(19) United States
(12) Patent Application Publication
(10) Pub. No.: US 2022/0241700 A1
(43) Pub. Date: Aug. 4, 2022

(54) Handheld Apparatus and Method to Conduct Solvent Extractions from Plant Matter using liquid Butane

(71) Applicant: Alfonso Gerardo BENAVIDES, Danville, CA (US)

(72) Inventor: Alfonso Gerardo BENAVIDES, Danville, CA (US)

(21) Appl. No.: 17/166,870

(22) Filed: Feb. 3, 2021

(51) Int. Cl. B01D 11/02; C11B 1/04; C11B 1/10

(52) U.S. Cl. CPC B01D 11/0207; C11B 1/104; B01D 11/0219; C11B 1/04

(57) ABSTRACT

An apparatus with method to conduct extractions from plant matter using liquid Butane as solvent and process quantities ranging from an eighth of an ounce to two ounces is disclosed. The apparatus is meant for individual use offering the convenience of size that allows it to be carried in a backpack, a suitcase, a handbag, a purse or a small bag. It is designed to be operated safely almost anywhere by almost anyone following a few simple instructions without requiring to be versed in the art of extractions using liquid Butane in commercial equipment. The risk of fire is minimized to the risk of using a common cigarette lighter due to the small volume of liquid Butane required to operate the extractor.

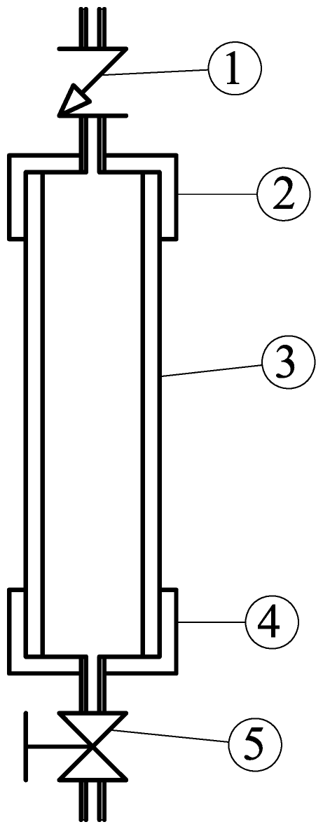

### BACKGROUND OF THE INVENTION

Liquid Butane is utilized as a solvent for extraction of oils, resins and other water insoluble substances.

These substances are to be extracted from plant matter such as roots, branches, bark, leaves, seeds and flowers.

Systems and equipment designed and built for such extractions using liquid Butane are designed and built to process quantities of plant matter ranging from pounds to tons per batch. Said extractors pose a significant risk of explosion and fire due to the amount of solvent i.e. pounds to tons of liquid Butane required for their operation. Said extractors must be operated in an industrial setting equipped with explosion proof forced ventilation and fire suppression capabilities. In addition, said extractors are meant to be operated only by trained individuals with technical expertise in the field of extractions handling these large amounts of liquid flammable and explosive gas. There is no extractor that uses liquid Butane as solvent made available to the public that is designed and built to process from an eighth of an ounce to two ounces of plant matter per batch. In addition, there is no extractor using liquid Butane as a solvent designed and built to be operated safely by almost any individual and almost anywhere provided with a few simple instructions, following a few precautionary measures and without requiring expertise in the field of solvent extractions and without using large quantities of pressurized liquid Butane.

The handheld extractor subject of this disclosure fills all those voids in the solvent extraction from plant matter using liquid Butane equipment market. This apparatus is intended for use by any individual who wants to make his/her own extraction processing from ⅛ to 2 ounces of plant matter and using from ½ to 5 ounces of liquid Butane as a solvent per extraction and recover substances from said plant matter in quantities only enough for personal use.

In addition, this apparatus is designed and built to be pressure filled with liquid Butane at ambient temperature and immerse the plant matter in liquid Butane. Other relatively small extractors available use liquid Butane to rinse or flush and not to immerse plant matter in liquid Butane thus requiring a much higher consumption of Butane and posing a much greater risk of fire and/or explosion.

### BRIEF SUMMARY OF THE INVENTION

The apparatus subject of this disclosure consists of the following parts or components:
A vessel to lodge plant matter and to be filled with liquid Butane with the purpose of extracting organic substances like oils, resins and other non-water-soluble substances from said plant matter.
A solvent inlet one-way valve or check valve to only admit into but not let escape gaseous or liquid Butane from the above-mentioned vessel.
A solvent and extract Discharge Valve to release gaseous and liquid Butane from the vessel carrying in solution the substances extracted from the plant matter.
Caps, lids, or other sealable openings or other means to access the internal cavity of the above-mentioned vessel to fill with plant matter and discharge the exhausted plant matter from said vessel.
The entire apparatus small enough to be held while operated by the user in his/her hands and small enough to be carried around in a backpack, a suitcase, a briefcase, a purse or a personal bag.

The manner to operate the apparatus subject of this disclosure would be as follows:
Assemble the apparatus leaving one opening uncovered to admit into it the plant matter to be processed.
Pack into the apparatus the desired amount of pant matter to be processed up to its capacity.
Seal the apparatus.
Flush the vessel internal cavity through its valves with gaseous Butane to expel air from the vessel.
Admit liquid Butane in the desired amount up to capacity to wet and wash the plant matter in the vessel.
Allow the liquid Butane to remain in contact with the plant matter for the desired period.
Release from the vessel the liquid Butane carrying the extracted substances and collect the liquid on a suitable container for further processing of it to recover extracted substances.
After the extraction is completed empty and clean the vessel to use again over and over.

### BRIEF DESCRIPTION OF THE DRAWING

Drawing 1 of 1 shows the complete view of the preferred embodiment of the apparatus subject of this disclosure.

The apparatus shown is composed of the following parts:

Inlet Valve (1)

Inlet cap (2)

Extraction Vessel (3)

Discharge cap (4)

Discharge Valve (5)

### DETAILED DESCRIPTION OF THE INVENTION

In the preferred embodiment of the apparatus subject of this disclosure the apparatus is composed of the following five basic parts described next:

Inlet Valve (1). This valve shall be a one-way valve and meant to only admit gas or liquid Butane into the Extraction Vessel (3) but not let gas or liquid or any other contents out of said vessel through it. This valve shall be able to accommodate the discharge tip or filling nozzle of a commercial Butane lighter refilling can, the kind of Butane refill can that sells for Butane cigarette lighter refill. This valve shall be made of materials chemically resistant to liquid Butane. This valve shall be attached to the Extraction Vessel (3) or Inlet Cap (2) and secured in place by any mechanical means i.e. threaded, screwed, flanged, bolted, clamped, glued, etc. This valve shall be pressure rated to a minimum of 75 Pounds per Square Inch, in other words a minimum of 1.5 times the maximum internal pressure exerted by liquid or gaseous Butane in the Extraction Vessel (3) at a maximum temperature of 110 degrees Fahrenheit. This valve shall withstand a maximum operating temperature of 110 degrees Fahrenheit without deforming, leaking or detaching from where it is affixed. This valve is to be permanently attached directly to the Extraction Vessel (3) or to a vessel cap.

Inlet Cap (2). This cap is meant to be removed to fill the Extraction Vessel (3) with the plant matter to be processed for extraction and then placed back and secured to said vessel to seal it. This cap is the ideal location for permanently affixing the Inlet Valve (1). This cap shall be attached to the Extraction Vessel (3) and secured in place by any mechanical means i.e. threaded, screwed, flanged, bolted, clamped, etc. This cap shall be pressure rated to a minimum of 75 PSI. This cap shall withstand a maximum operating temperature of 110 degrees Fahrenheit without deforming, leaking, detaching or coming loose. This cap can be made of any material like plastic, glass, ceramic, metal or any other along the material is chemically resistant to liquid Butane. This cap shall be resistant to an impact equivalent to being dropped over a solid surface from a height not greater than 4 feet above said surface and without as consequence this cap cracking, shattering or deforming. In the preferred embodiment of this invention, the Inlet Cap (2) is a threaded schedule 40 gray PVC pipe cap. In the preferred embodiment of this invention The Inlet Valve (1) will be inserted through a hole drilled on top of the Inlet Cap (2) and attached by mean of a Butane resistant cyanoacrylate glue or other means of affixing the Inlet Valve (1) to the Inlet Cap (2).

Extraction Vessel (3). The purpose of this vessel is to lodge and hold the plant matter to be processed for extraction. This vessel internal cavity shall be accessible through a sealable opening to fill into and discharge from this vessel the plant matter. This vessel shall always be transparent or equipped with a sight glass or other means to enable inspection of the plant matter especially while this vessel is pressurized with liquid Butane. This vessel shall be rated to withstand a minimum of 75 PSI. This vessel shall withstand a maximum operating temperature of 110 degrees Fahrenheit without deforming, leaking or losing its transparency due to temperature, pressure or contact with liquid Butane. This vessel can be made of any material like plastic, glass, ceramic, metal or any other along the material is chemically resistant to liquid Butane. This vessel shall be resistant to an impact equivalent to being dropped over a solid surface from a height not greater than 4 feet above said surface and without as consequence this vessel cracking, shattering or deforming. In the preferred embodiment of this invention the Extraction Vessel (3) is a threaded section of scheduled 40 clear PVC pipe.

Discharge Cap (4). This cap is meant to allow more access to the Discharge Valve (5) and allow more access to the Extraction Vessel (3) internal cavity. This cap is an ideal location for attaching the Discharge Valve (5). This cap shall be attached to the Extraction Vessel (3) and secured in place by any mechanical means i.e. threaded, screwed, flanged, bolted, clamped, etc. This cap shall be pressure rated to a minimum of 75 PSI. This cap shall withstand a maximum operating temperature of 110 degrees Fahrenheit without deforming, leaking or detaching. This vessel can be made of any material like plastic, glass, ceramic, metal or any other along the material is chemically resistant to liquid Butane. This vessel shall be resistant to an impact equivalent to being dropped over a solid surface from a height not greater than 4 feet above said surface and without as consequence this vessel cracking, shattering or deforming. In the preferred embodiment of this invention the Discharge Cap (4) is a schedule 40 threaded brass or threaded gray PVC reducing connector. Also, in the preferred embodiment of this invention, the reducing connector would be the means to attach the Discharge Valve (5) to the Extraction Vessel (3).

Discharge Valve (5). The purpose of this valve is to depressurize the Extraction Vessel (3) and to discharge gaseous or liquid Butane and substances extracted from the plant matter in the Extraction Vessel (3). This valve shall be designed for very gradual opening to allow a very controlled release of gas pressure or liquid Butane from the Extraction Vessel (3). This valve shall be pressure rated to a minimum of 75 Pounds per Square Inch. This valve shall be suitable to operate at and shall withstand a maximum operating temperature of 110 degrees Fahrenheit without deforming, leaking or detaching. This vessel can be made of any material like plastic, glass, ceramic, metal or any other along the material is chemically resistant to liquid Butane. This valve shall be resistant to an impact equivalent to being dropped over a solid surface from a height not greater than 4 feet above said surface and without as consequence this valve cracking, shattering or deforming. In the preferred embodiment of this invention, the Discharge Valve (5) is a Needle Valve.

The assembled apparatus shall be pressure rated for 75 PSI, shall withstand a maximum operating temperature of 110 degrees Fahrenheit without deforming, leaking, coming apart or any component detaching or coming loose due to temperature or pressure. The apparatus assembled shall be resistant to an impact equivalent to being dropped over a solid surface from a height not greater than 4 feet above said surface and without as consequence any part of the apparatus cracking, shattering, detaching, coming loose or releasing Butane from it.

To assemble the Handheld extractor apparatus subject of this disclosure to conduct an extraction using liquid Butane the next steps shall be followed:
All part shall be cleaned with soap and water or with alcohol like Ethanol or Isopropanol. All parts shall be dry and free of any debris or buildup.
All parts shall be inspected for cracks or any other damage. Any damaged part shall not be used nor attempted to be repaired, any damaged part shall be discarded and replaced.
If parts are to be threaded together, threads shall be applied 7 turns of inert sealing plumbing tape commonly known as “Teflon tape”. Tape shall be wrapped in the same direction of rotation of the part to be threaded on.
Discharge Valve (5) shall be attached to Discharge Cap (4) and secured to prevent any leaks of Butane.
Discharge Cap (5) shall be attached to vessel and secured to prevent any leaks of Butane.
A clean small ball of cotton, fabric, filter paper or other means of preventing plant matter in the Extraction Vessel (3) cavity from reaching the Discharge Valve (5) shall be packed against the Discharge Valve (5) opening at the inside bottom of the Extraction Vessel (3) cavity. This packed material shall allow proper operation and sealing of the Discharge Valve (5), without blocking the Discharge Valve (5) passage of Butane gas or liquid Butane carrying extracted materials dissolved in it.
Next, plant matter shall be packed into the Extraction Vessel (3) cavity.
A clean small ball of cotton, fabric, filter paper or other means of preventing plant matter in the Extraction Vessel (3) cavity from reaching the Inlet Valve (1) shall be packed over the plant matter on the top end of the Extraction Vessel (3) cavity. This packed material shall allow proper operation and sealing of the Inlet Valve (1), without blocking said valve passage of Butane gas or liquid Butane into the Extraction Vessel (3) cavity.
Next the Inlet Cap (2) shall be firmly attached to the Extraction Vessel (3) already packed with plant matter. All threaded connections preferably will be installed and “hand tightened”.
The Handheld extractor using liquid Butane is ready to be operated.

To conduct an extraction from Plant Matter using the Handheld extractor apparatus using liquid Butane subject of this disclosure, the following procedure shall be followed:
Ensure the extractor is properly packed with plant matter to process and all joints are properly sealed preferably “hand tight”.
Open Discharge Valve (5).
Turn the extractor upside down with the Discharge Valve (5) pointing upward towards a safe place free of sparks and free of open flames in a well-ventilated area, preferably outdoors.
Take a Butane gas lighter refill can and inject gaseous Butane through the Inlet Valve (1) into the Extractor Vessel (3) cavity allowing the Butane gas to escape through the Discharge Valve (5). Do this for a few seconds to push and sweep out all air trapped with the plant matter inside of the Extraction Vessel (3).
Close the Discharge Valve (5).
Turn the extractor right side up with the Inlet Valve (1) pointing up and the closed Discharge Valve (5) pointing down.
This time take a Butane gas lighter refill can and turn it upside down with its fill nozzle pointing downward.
Inject liquid Butane from the fill can into the Extraction Vessel (3) cavity. Observe how the plant matter gets soaked with liquid Butane as it is entering into the vessel. Ensure that enough liquid Butane is injected into the vessel to wet all plant matter. If gaseous Butane does not allow enough liquid Butane to enter the vessel, stop the filling operation, turn the extractor upside down and carefully release a little Butane gas from the extractor while pointing the extractor's Discharge Valve (5) upwards towards a safe place like before. Then close the Discharge Valve (5), turn the extractor right side up and continue the liquid Butane injection into the extractor.
Once the level of liquid Butane in the extractor is enough to cover the plant matter in it, allow the plant matter to soak in the liquid Butane for a few minutes.
Procure yourself an open top container large enough to receive the liquid contents of the extractor. Said container shall be made of a material chemically resistant to liquid Butane.
When ready to discharge and collect the liquid Butane from the extractor, take the extractor and place it right side up with the Discharge Valve (5) pointing downwards aligned to discharge into the receiving container.
Holding the extractor with one hand slowly open the Discharge Valve (5) with the other hand letting the liquid Butane trickle into the receiving container until the extractor has been depressurized. During this operation liquid Butane in the container will be evaporating into gas. Conduct this operation in a place free of sparks and free of open flames and in a well-ventilated area preferably outdoors.
The liquid Butane injection, soaking and discharge steps can be repeated as necessary.
Once the extraction has been completed ensure the Extraction Vessel (3) has been depressurized.
Proceed to remove with caution the Inlet Cap (2) ensuring the vessel is not under any internal pressure, remove next the Discharge Cap (5).
Empty the contents of the vessel, clean and prepare the extractor for the next extraction.

The volume of liquid Butane used by this apparatus shall be at the most in the order of a couple of hundreds cubic centimeters while other extractors in the market use liquid Butane in the order of litters.

Litters of liquid Butane released and not properly and safely ventilated can collect in spaces rendering a high risk of explosion and fire.

I claim:

1. An apparatus and method to conduct extractions from plant matter using liquid Butane as solvent. This apparatus to be referred hereafter as an extractor and the process conducted in it to be referred hereafter as a solvent extraction using liquid Butane.

2. The extractor of claim 1 composed of the following basic parts: inlet valve, inlet and/or discharge cap, vessel, discharge valve.

3. The extractor of claim 2 with capability of being filled with plant matter and filled and pressurized with enough liquid Butane to immerse all plant matter in the extractor with said liquid Butane and soak said plant matter for any desired period of time to dissolve and extract from said plant matter substances soluble in liquid Butane.

4. The extractor of claim 3 small enough to be carried in a backpack, a suitcase, a handbag, a purse or a small bag.

5. The extractor of claim 4 small enough to process from an eighth of an ounce to two ounces of plant matter.

6. The extractor of claim 5 designed and built to operate at a maximum temperature of 110 degrees Fahrenheit.

7. The extractor of claim 6 designed and built to operate at a maximum pressure of 75 Pounds Per Square Inch.

8. The extractor of claim 7 with parts and components made of any material such as metal, plastic, glass, ceramic or other with the sole condition that said materials the extractor is made of will not dissolve, not deform, not swollen, not soften, not become brittle, not crack, not deteriorate in any form and will be chemically inert and resistant to liquid Butane.

9. The extractor of claim 8 whose individual parts or as an assembly shall be resistant to an impact equivalent to being dropped over a solid surface from a height not greater than 4 feet above said surface and without as a consequence cracking, shattering, detaching, coming loose or leaking.

10. The extractor of claim 9 where the inlet valve is a one-way valve or check valve only allowing gas or liquid Butane into the extractor but not allowing Butane or any other material escape through said valve.

11. The extractor of claim 10 where the vessel is made of a transparent material or has means to visually inspect the plant matter inside of it while being pressurized with liquid or gaseous Butane.

12. The extractor of claim 11 where the discharge valve is designed to gradually increase its opening to let escape liquid or gas from the extractor in a very controlled manner. In the preferred embodiment of this invention the discharge valve is a needle valve.

13. The extractor of claim 12 designed and built to process from ⅛ to 2 ounces of plant matter per batch for extraction.

14. The extractor of claim 13 with a method of operation that involves the steps of: assembling apparatus, fill with plant matter, purge with gaseous Butane, fill with liquid Butane, let plant matter be soaked in liquid Butane over a period of time, gradually depressurize collecting the liquid Butane carrying the substances extracted, repeat the fill with liquid Butane-soak-discharge liquid steps as desired, depressurize the extractor, empty of exhausted plant matter, clean all parts and prepare for next extraction.

15. The extractor of claim 14 where the inlet valve is the kind of one-way valve that will admit the nozzle or filling tip of a common commercial Butane lighter refill can, the kind of cans made available to refill Butane cigarette lighters.

16. The extractor of claim 15 designed and built to be assembled and disassembled entirely by hand seldom requiring one small wrench and with all joints and connections intended to be tightened by hand.

17. The extractor of claim 16 requiring for its operation from ½ ounce to 5 ounces of liquid Butane per extraction.
